(19) United States
(12) Patent Application Publication
(10) Pub. No.: US 2012/0257722 A1
(43) Pub. Date: Oct. 11, 2012

(54) X-RAY EMITTER

(76) Inventor: Guenter Heidrich, Gerhardshofen (DE)

(21) Appl. No.: 13/444,071

(22) Filed: Apr. 11, 2012

(30) Foreign Application Priority Data
Apr. 11, 2011 (DE) 10 2011 007 114.8

(51) Int. Cl. H01J 35/10

(52) U.S. Cl. 378/131

(57) ABSTRACT

An x-ray emitter has a rotating envelope x-ray tube that is rotatably mounted on a shaft in an emitter housing filled with a cooling and insulating agent, and a drive apparatus coupled to the rotating envelope x-ray tube by the shaft. The emitter housing is hermetically sealed and the drive apparatus includes a predetermined number of permanent magnets as well as electromagnets corresponding thereto. The permanent magnets are arranged within the emitter housing and alternate annularly around the shaft in terms of their polarity. The electromagnets are arranged on an exterior of the emitter housing and can be controlled by a control and regulating unit to produce a rotating alternating field. The x-ray emitter is suited to high rotational speeds and/or to high pressures of the cooling and insulating agent in the emitter housing.

### BACKGROUND OF THE INVENTION

1. Field of the Invention

The present invention relates to an x-ray emitter of the type having a rotating envelope x-ray tube, which is rotatably mounted on a shaft in an emitter housing filled with a cooling and insulating agent, and having a drive apparatus coupled to the rotating envelope x-ray tube by the shaft. Furthermore, the invention relates to a method for operating such an x-ray emitter having a rotating envelope x-ray tube.

2. Description of the Prior Art

An x-ray emitter of the above general type is known for instance from DE 10 2004 056 110 A1. A rotating envelope x-ray tube having a vacuum housing is rotatably mounted in this x-ray emitter. An x-ray emitter of this type is therefore also referred to as rotating envelope x-ray emitter. The rotating envelope x-ray tube contains a rotating anode that is permanently connected to the vacuum housing as well as a cathode that emits electrons. The rotating envelope x-ray tube is driven by means of a drive apparatus (not described in more detail) which is mechanically coupled to a shaft connected to the rotating envelope x-ray tube.

### SUMMARY OF THE INVENTION

An object of the present invention is to further develop an x-ray emitter of the type described above, in particular with respect to higher rotational speeds and/or higher pressures on the cooling and insulating agent in the emitter housing.

The x-ray emitter according to the invention a rotating envelope x-ray tube, which is rotatably mounted on a shaft in an emitter housing filled with a cooling and insulating agent, and a drive apparatus, which is coupled to the rotating envelope x-ray tube by the shaft. In accordance with the invention, the emitter housing is designed to be hermetically sealed and the drive apparatus includes a predeterminable number of permanent magnets as well as electromagnets corresponding thereto. The permanent magnets are arranged within the emitter housing and alternate annularly around the shaft in terms of their polarity. The electromagnets are arranged on an exterior of the emitter housing and can be controlled by a control and regulating unit such that a rotating alternating field is produced.

Insulation oil and sulfur hexafluoride (SF⁶) are suitable for instance as a cooling and insulating agent. Other liquid or gaseous cooling and insulating agents can also be used to cool the rotating envelope x-ray tube and to insulate the rotating envelope x-ray tube from the emitter housing lying at earth potential.

The drive apparatus provided in accordance with the invention with the x-ray emitter forms a magnetic due to its structure (permanent magnets inside and electromagnets outside of the emitter housing) and acts as a direct drive for the rotating envelope x-ray tube. In other words, it functions as a gearless drive.

The advantage of the inventive solution for transmitting torque in the x-ray emitter according to the invention is primarily in allowing the emitter housing to be configured without a shaft feedthrough, as a result of which a hermetically sealed emitter housing can be realized without problem.

Also of advantage is the fact that, compared with conventional drives, driving the tube via the magnetic coupling is particularly tolerant of angle errors. A minimal parallel misalignment between the permanent magnets inside and the electromagnetic outside of the emitter housing, which may occur on account of mounting tolerances, does not result in any problems when driving the rotating envelope x-ray tube.

Due to the magnetic coupling, high rotational speeds of the x-ray tubes of for instance above 10.000 revolutions per minute can be realized at the same time as high overpressure of the cooling and insulating agent in the emitter housing of for instance above 5 bar (500 kPA), so leakages in the emitter housing are excluded in the area of the drive apparatus by virtue of the construction.

The magnetic coupling provided to transmit the torque onto the x-ray tube preferably comprises coupling elements equipped with permanent magnets. Samarium-cobalt magnets or neodymium-iron-boron magnets are suitable as magnets for instance.

In a preferred embodiment of the x-ray emitter, the shaft and the drive apparatus are coupled to one another by an insulation coupling arranged inside of the emitter housing, whereby the permanent magnets of the drive apparatus are held in the insulation coupling.

The insulation element in this case is preferably manufactured at least partly from plastic, in particular from a high temperature-resistant thermoplastic plastic, e.g. a polyaryletherketone (PAEK) such as polyetheretherketone (PEEK).

According to a further embodiment of the x-ray emitter, the emitter housing has a wall segment made of a non-magnetic metal, for instance aluminum, in the region of the permanent magnets and the electromagnets.

According to an alternative embodiment to the afore-cited embodiment, the emitter housing has a wall segment made of fiber-reinforced plastic in the region of the permanent magnets and the electromagnets. A plastic of this type is adequately mechanically and thermally stable, particularly when strengthened with carbon fibers.

### BRIEF DESCRIPTION OF THE DRAWINGS

The invention and further advantageous embodiments are explained in more detail below with the aid of a schematically represented exemplary embodiment in the drawings, but are not restricted to the exemplary embodiment.

FIG. 1 shows an embodiment of an inventive x-ray emitter.

FIG. 2 shows a top view of the part of a drive apparatus of the x-ray emitter arranged in the emitter housing according to FIG. 1.

FIG. 3 shows a top view of the part of a drive apparatus of the x-ray emitter according to FIG. 1 arranged on the front face of the emitter housing.

### DESCRIPTION OF THE PREFERRED EMBODIMENTS

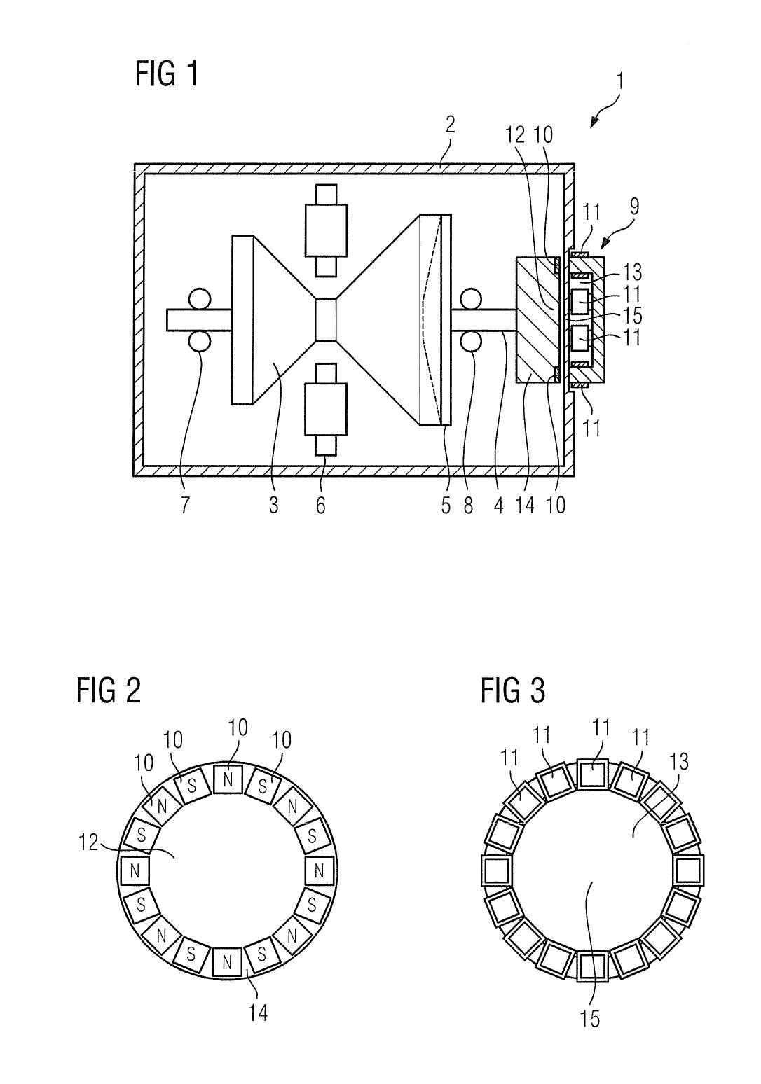

An x-ray emitter of the general type known for instance from DE 10 2004 056 110 A1 cited in the introduction is designated with 1 in FIG. 1. The x-ray emitter 1 differs from the known emitter as described below.

The x-ray emitter 1 includes an emitter housing 2 filled with insulation oil (cooling and insulating agent). A rotating envelope x-ray tube 3 is rotatably mounted in the emitter housing 2 by means of a shaft 4.

A cathode (not shown) arranged within the evacuated rotating envelope x-ray tube 3 (in the left region of the x-ray tube 3 in the arrangement according to FIG. 1) emits electrons, which are accelerated to the desired primary energy by way of a high voltage prevailing between the cathode and the anode 5 and are influenced by a deflection system 6 in their trajectory. The rotating envelope x-ray tube is operated for instance with a high voltage of 70 kV compared with the emitter housing 2 lying on the earth potential.

When electrons strike the material of the anode 5 in the occupied area of the focal point, the kinetic energy of the electrons is partially (approx 1%) converted into x-ray radiation by the interaction of the electrons with the atomic nuclei of the anode material. By far the greatest portion of energy is to be dissipated by the rotating envelope x-ray tube 3 in the form of heat. This is done with the use of the insulation oil contained in the emitter housing 2.

The shaft 4 that supports the rotating envelope x-ray tube 3 is rotatably mounted by two bearings 7 and 8, which are embodied as ball bearings in the exemplary embodiment shown. The shaft 4 is also coupled to a drive apparatus 9, as a result of which the shaft 4 and thus the rotating envelope x-ray tube 3 can be made to rotate.

In the x-ray emitter 1 shown in FIG. 1, in accordance with the invention the drive apparatus 9 includes a predeterminable number of permanent magnets 10 and electromagnets 11 corresponding thereto. The permanent magnets 10 are in this case arranged inside of the emitter housing 2 and alternate annularly around the shaft 4 in terms of their polarity and therewith form an internal part 12 of the drive apparatus 9. On the other hand, the electromagnets 11 are arranged on an exterior of the emitter housing 2 and therewith form an external part 13 of the drive apparatus 9. The drive apparatus 9 is thus embodied in two parts, whereby the internal part 12 is arranged on the rotatable shaft 4 in a rotation-free fashion and the external part 13 is connected to the emitter housing in a force-fit fashion. The electromagnets 11 can be controlled by a control and regulating unit (not shown in FIG. 1) such that a rotating alternating field is produced. The internal part 12 with the permanent magnets 10 will follow the alternating field of the electromagnets 11 arranged in the external part 13.

In the embodiment of the inventive x-ray emitter 1 shown in FIG. 1, the permanent magnets 10 of the drive apparatus 9 are held in an insulation coupling 14, which is fastened to the shaft within the emitter housing 2 so as to prevent rotation. The shaft 4 is therefore magnetically coupled to the electromagnets 11 arranged outside of the emitter housing (external part 13 of the drive apparatus) by the permanent magnets 10 (internal part 12 of the drive apparatus 9) within the emitter housing 2.

The insulation coupling 12 made of high temperature-resistant thermoplastic plastic, e.g. a polyaryletherketone (PAEK), in particular polyetheretherketone (PEEK). Other materials resistant to high temperatures are also suitable herefor, for instance ceramic materials.

The emitter housing 2 has a non-magnetic wall segment 13 in the region of the permanent magnets 10 and the electromagnets 11. The wall segment 13 may be formed, for instance, of a non-magnetic metal or a fiber-reinforced plastic.

The wall segment 13 in the emitter housing 2 is embodied such that both the necessary pressure resistance and also the transferability of the magnet forces and thus of the torque provided by the electromagnets 11 from the exterior to the interior of the emitter housing 2 is ensured.

In the shown embodiment, this is achieved by a disk-type wall segment 13. The wall segment can however also be embodied in the manner of a pot for instance in order to provide a large surface area with at the same time a high mechanical strength.

The wall segment 13 can be manufactured for instance from aluminum, glass or fiber-reinforced plastic, as a function of the structural boundary conditions of the emitter housing 2. The material of the wall segment 13 does not necessarily differ from the material of the emitter housing 2 used outside of the wall segment 13.

Since the inventive solution does not have a sealed shaft feedthrough for an electric motor coupled to the shaft, which serves as a drive apparatus in the prior art, the complete emitter housing 2 of the x-ray emitter 1 is hermetically sealed. Dynamic sealings, such as are needed for a shaft feedthrough, are therefore unnecessary in the inventive solution. The x-ray emitter 1 is therefore suited both to operation at high rotational speeds of the x-ray tube 3 and also to high overpressure in the emitter housing 2.

When viewed from the front (FIG. 2), a magnetic north pole and a magnetic south pole alternate with the permanent magnet 10 in the case of an internal part 12 of the drive apparatus 9. Different locking positions are thus possible between the parts 12 and 13 of the drive apparatus 9 which are always distanced from one another.

In the exemplary embodiment shown, the internal part 12 of the drive apparatus 9 comprises 16 permanent magnets (FIG. 2) and the external part 13 includes 16 electromagnets 11 (FIG. 3). Eight different angular positions therefore result. Should the parts 12 and 13 of the drive apparatus 9 slip on account of overload, they lock together again in the next locking position.

As apparent from the description of the exemplary embodiment shown in FIGS. 1 to 3, the inventive x-ray emitter 1 allows the torque needed to drive the rotating envelope x-ray tube 3 to be transmitted in a non-contact fashion from the drive apparatus 9 to the rotating envelope x-ray tube 3.

Although modifications and changes may be suggested by those skilled in the art, it is the intention of the inventor to embody within the patent warranted hereon all changes and modifications as reasonably and properly come within the scope of his contribution to the art.

I claim as my invention:

1. An x-ray emitter comprising:
a rotating envelope x-ray tube;
a hermetically sealed emitter housing filled with a cooling and insulating agent in which said rotating envelope x-ray tube is contained;
a shaft connected to said rotating envelope x-ray tube in said emitter housing, said shaft being rotatably mounted in said emitter housing; and
a drive apparatus connected to said shaft and configured to rotate said shaft and said rotating envelope x-ray tube inside said emitter housing, said drive apparatus comprising a predetermined number of permanent magnets located inside said emitter housing that alternate annularly around said shaft with regard to polarity of said permanent magnets, and a corresponding plurality of electromagnets located outside of said emitter housing and operable by a control and regulating unit to produce a rotating alternating field that rotates said shaft and said rotating envelope x-ray tube.

2. An x-ray emitter as claimed in claim 1 wherein said permanent magnets are samarium-cobalt magnets.

3. An x-ray emitter as claimed in claim 1 wherein said permanent magnets are neodymium-iron-boron magnets.

4. An x-ray emitter as claimed in claim 1 comprising an insulator coupling located inside said emitter housing and connected to said shaft, said permanent magnets of said drive apparatus being contained in said insulator coupling.

5. An x-ray emitter as claimed in claim 4 wherein said insulator coupling is comprised at least partially of plastic.

6. An x-ray emitter as claimed in claim 5 wherein said plastic is polyetheretherketone.

7. An x-ray emitter as claimed in claim 1 wherein said emitter housing comprises a wall segment comprised of non-magnetic metal at which said permanent magnets and said electromagnets are located.

8. An x-ray emitter as claimed in claim 1 wherein said emitter housing comprises a wall segment comprised of fiber-reinforced plastic at which said permanent magnets and said electromagnets are located.

9. A method for operating an x-ray emitter comprising:
enclosing a rotating envelope x-ray tube inside a hermetically sealed housing filled with a cooling and insulating agent;
rotating said rotating envelope x-ray tube in said emitter housing with a shaft and coupling a drive apparatus to said shaft that rotates said shaft; and
coupling said drive apparatus to said shaft, and transmitting torque to said shaft, magnetically and contact-free.
